(19) United States
(12) Patent Application Publication
(10) Pub. No.: US 2007/0052621 A1
(43) Pub. Date: Mar. 8, 2007

(54) Method for driving gas discharge display device

(75) Inventors: Hitoshi Hirakawa, Kawasaki (JP); Manabu Ishimoto, Kawasaki (JP); Kenji Awamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/593,597

(22) Filed: Nov. 7, 2006

Related U.S. Application Data
(63) Continuation of application No. PCT/JP04/07089, filed on May 25, 2004.

(51) Int. Cl. G09G 3/28

(52) U.S. Cl. 345/60

(57) ABSTRACT

In order to realize a display having good contrast and stable addressing by using a gas discharge display device having a screen of a three-electrode surface discharge structure having a characteristics that a counter discharge start voltage is higher than a surface discharge start voltage, prior to starting of initialization of an electrified state as canceling of setting of addressing that was performed last, positive charge is formed between opposed electrodes so that a discharge can be generated easily in the addressing after the initialization, and the initialization is performed so that the formed positive charge does not vanish.

### CROSS REFERENCE TO RELATED APPLICATIONS

This application is a continuing application, filed under 35 U.S.C. §111(a), of International Application PCT/JP2004/007089, filed May 25, 2004, the contents of which are incorporated by reference herein.

### TECHNICAL FIELD

The present invention relates to a method for driving a gas discharge display device having a plurality of discharge cells that are capable of selective light emission. The gas discharge display device can be a display tube, a display device made up of a plurality of display tubes, and a plasma display panel.

### BACKGROUND ART

A three-electrode surface discharge plasma display panel that is used for displaying color images includes a pair of substrates that are opposed to each other via a discharge gas space, display electrodes arranged on a first substrate, a dielectric layer and a protection film covering the display electrodes, a partition dividing the discharge gas space, address electrodes arranged on a second substrate, and a fluorescent material layer that covers the address electrodes for color display. In each of the discharge cells constituting a screen, a pair of the display electrodes (the first and the second electrodes) is adjacent to each other via a surface discharge gap on the front or back side of the discharge gas space. In addition, the pair of display electrodes and the address electrodes (third electrodes) are opposed to each other via the discharge gas space.

In a mass production of plasma display panels, a thickness of the dielectric layer and a height of the partition have a restriction. In order to lower a driving voltage in a display discharge, it is desirable to make the dielectric layer thin. The thinner the dielectric layer is, the easier a surface discharge is generated between display electrodes so that the driving voltage can be lowered. When a thickness of the dielectric layer is decreased, however, a discharge current increases so that light emission efficiency is lowered while a heat value increases. In addition, the dielectric layer is required to have good quality without voids for preventing a dielectric breakdown. On the other hand, in order to realize a screen having a high definition and high light emission efficiency, it is desirable that a height of the partition be high. The higher the partition is, the larger the discharge gas space is, so that excitation efficiency is enhanced and the area in which the fluorescent material is arranged increases. When a height of the partition is increased, a defect such as a flake or a dent in the formation stage of the partition may be generated easily so that a yield is decreased.

The plasma display panel that is designed under the restriction described above has inherently a structural characteristic that a surface discharge start voltage between the display electrodes is higher than a counter discharge start voltage between the display electrode and the address electrode. More specifically, when a thickness of the dielectric layer is 30 μm and a height of the partition 140 μm, the surface discharge start voltage is approximately 240 volts while the counter discharge start voltage is approximately 180 volts. Note that even if the dielectric layer is made thinner so that the surface discharge start voltage is lowered, the display electrode becomes closer to the address electrode without increasing the height of the partition because the dielectric layer becomes thinner. Therefore, the counter discharge start voltage is also lowered, so that the above-mentioned relationship in which the surface discharge start voltage is higher than the counter discharge start voltage is maintained.

When the plasma display panel is driven, a sub frame method is used in which a frame is replaced with a plurality of sub frames. Therefore, a resetting step, an addressing step and a sustaining step are usually performed on each of the sub frames. The resetting step is a process for initializing an electrified state of the dielectric layer in all the discharge cells (hereinafter referred to as cells). The addressing step is a process for setting a binary value of the electrified state of the dielectric layer in each cell in accordance with corresponding sub frame data. The sustaining step is a process for generating a discharge a predetermined number of times in cells to be energized that have become a state with a predetermined quantity of wall charge.

In the addressing step, one (the second electrode) of the pair of display electrodes is a scanning electrode for selecting a row of a matrix display, while the address electrode is a data electrode for giving binary information to discharge cells on the selected row. An address discharge is generated between the display electrode of the selected row and the address electrode of the selected column so that wall charge of the selected cell is controlled.

When the address discharge is generated, a voltage is applied between the display electrode and the address electrode so that the display electrode becomes a cathode. The reason is that the protection film of the dielectric layer covering the display electrodes is made of a material having a larger coefficient of secondary electron emission than the fluorescent material layer covering the address electrode, so the discharge start voltage is lower in the case where the display electrode is a cathode than in the case where it is an anode.

Prior to the address discharge, it is preferable to form wall charge of the positive polarity on the side of the address electrode that is the anode. Since the wall voltage is added to the driving voltage so that the discharge can be generated easily, a margin of the driving voltage increases so that reliability of the addressing is enhanced. Thus, it becomes possible to perform higher addressing.

For this reason, a conventional display by the plasma display panel uses a driving method in which the resetting step that is the addressing preprocessing includes forming charge on the address electrode side. In other words, the conventional driving method of the plasma display panel, in a resetting period, generates a discharge between display electrodes in all the cells for initializing wall charge in the dielectric layer related to the sustaining step and generates a discharge actively, between the address electrode and the display electrode, so that the address electrode becomes the cathode.

On the other hand, there is known a display device having a three-electrode surface discharge structure including many gas discharge display tubes arranged in parallel, which is a gas discharge display device more suitable for a large screen than a plasma display panel. This type of display device, which is disclosed in Japanese unexamined patent publication No. 2003-68214, includes many thin display tubes having no electrode and electrode supporting plates arranged on the front and the back sides of the display tubes. The display tube has a tubular shape with flat front and back faces, and electrodes on the electrode supporting plates that contact the front and the back faces of the display tubes define a plurality of discharge cells (hereinafter referred to as cells). In each of the display tubes, the plurality of cells are arranged in the axis direction of the tube, which corresponds to one column of the matrix display.

The display tube is suitable not only for a large screen but also for improving light emission efficiency. According to the display tube, each cell can easily have a sufficiently large discharge gas space by increasing a diameter of the glass tube that is an enclosure. In other words, the restriction of height of the partition in a plasma display panel as described above does not exist in the display tube. For example, if a glass tube having an inner diameter of 0.8 mm is used, a size of the discharge gas space in the front-back direction becomes four times or more the plasma display panel.

In a structural design of the display tube, the more the discharge gas space is enlarged in the front-back direction, the higher the counter discharge start voltage becomes. The display tube, which has a sufficiently large discharge gas space compared with a typical plasma display panel, has a structural characteristic that the counter discharge start voltage is higher than the surface discharge start voltage.

[Patent document 1] Japanese unexamined patent publication No. 2003-68214

[Non-patent document 1] K. Sakita et al. “Analysis of Cell Operation at Address Period Using Wall Voltage Transfer Function in Three-electrode Surface-Discharge AC-PDPs”, IDW'01, pp. 841-844, 2001.

### DISCLOSURE OF THE INVENTION

If the conventional driving method in which positive charge is formed on the address electrodes in the resetting period is applied to a display device having the counter discharge start voltage higher than the surface discharge start voltage, a drop of contrast due to a background light emission and a decrease of the margin of the driving voltage due to a discharge diffusion become conspicuous. The reason of this is as follows.

The address electrode is the anode in the addressing step while the address electrode is the cathode in the resetting period. However, since a complicated and expensive driver circuit is necessary for biasing the address electrode to a potential of the positive or the negative polarity, it is desirable that the bias of the address electrode be either positive or negative. Since it is necessary to apply a pulse to both the address electrode and the scanning electrode in the addressing step, a pulse of the positive polarity is applied to the address electrode. Therefore, the scanning electrode is biased to be the anode with respect to the address electrode in the resetting period. In this case, the bias voltage must be higher than the counter discharge start voltage. In the display device having the counter discharge start voltage higher than the surface discharge start voltage, a voltage that exceeds the surface discharge start voltage substantially is applied between the display electrodes by the bias of the scanning electrode. As a result, an excessively strong discharge is generated, which may cause the background light emission or the discharge diffusion.

An object of the present invention is to realize a stable display with high contrast by using a display device having a three-electrode surface discharge structure in which the counter discharge start voltage is higher than the surface discharge start voltage.

According to the present invention, formation of charge that contributes to decrease of addressing voltage is performed separately on a time scale from initialization of an electrified state at a vicinity of a pair of surface discharge electrodes. Prior to start of initialization of the electrified state for canceling setting of addressing that was performed last, positive charge for addressing that follows the initialization is formed between opposed electrodes, and the initialization is performed so that the formed positive charge does not vanish.

The present invention is applied to a gas discharge display device that includes a plurality of discharge cells. Each of the discharge cells includes a first electrode, a second electrode neighboring the first electrode, a third electrode that is opposed to the second electrode via a discharge gas space, a first insulator disposed between the first electrode as well as the second electrode and the discharge gas space, and a second insulator disposed between the third electrode and the discharge gas space. Each of the discharge cells has a structural characteristic that a discharge start voltage between the third electrode that is, at least, a cathode and the second electrode is higher than a discharge start voltage between the first electrode and the second electrode. The driving method includes an addressing step for forming a state in which a necessary quantity of wall charge is accumulated in the first insulator in discharge cells to be energized, a sustaining step for generating a discharge between the first electrode and the second electrode in the discharge cells to be energized, and a resetting step for initializing the wall charge in the first insulator in all the discharge cells. In the addressing step, a discharge is generated by using the third electrode as an anode between the second electrode and the third electrode in the discharge cells to be energized or discharge cells to be not energized. In the sustaining step, the wall charge of a positive polarity is accumulated in the second insulator in all the discharge cells. In the resetting step, a discharge is generated not between the second electrode and the third electrode but between the first electrode and the second electrode. The present invention is also applied to a gas discharge display device in which a discharge start voltage between the third electrode that is the anode and the second electrode is higher than a discharge start voltage between the first electrode and the second electrode.

According to the present invention, a stable display having a good contrast can be realized by a display device having a three-electrode surface discharge structure in which the counter discharge start voltage is higher than the surface discharge start voltage.

### BRIEF DESCRIPTION OF THE DRAWINGS

FIG. 1 is a diagram showing an outline of a general structure of a display device according to the present invention.

FIG. 2 is a diagram showing a structure of a main part of the display device.

FIG. 3 is a diagram showing a structure of a discharge cell.

FIG. 4 is a diagram showing a concept of driving processes according to the present invention.

FIG. 5 is a diagram showing an example of driving voltage waveforms.

FIG. 6 is a diagram showing a variation of the driving voltage waveforms.

FIG. 7 is a diagram showing an example of a plasma display panel.

### BEST MODE FOR CARRYING OUT THE INVENTION

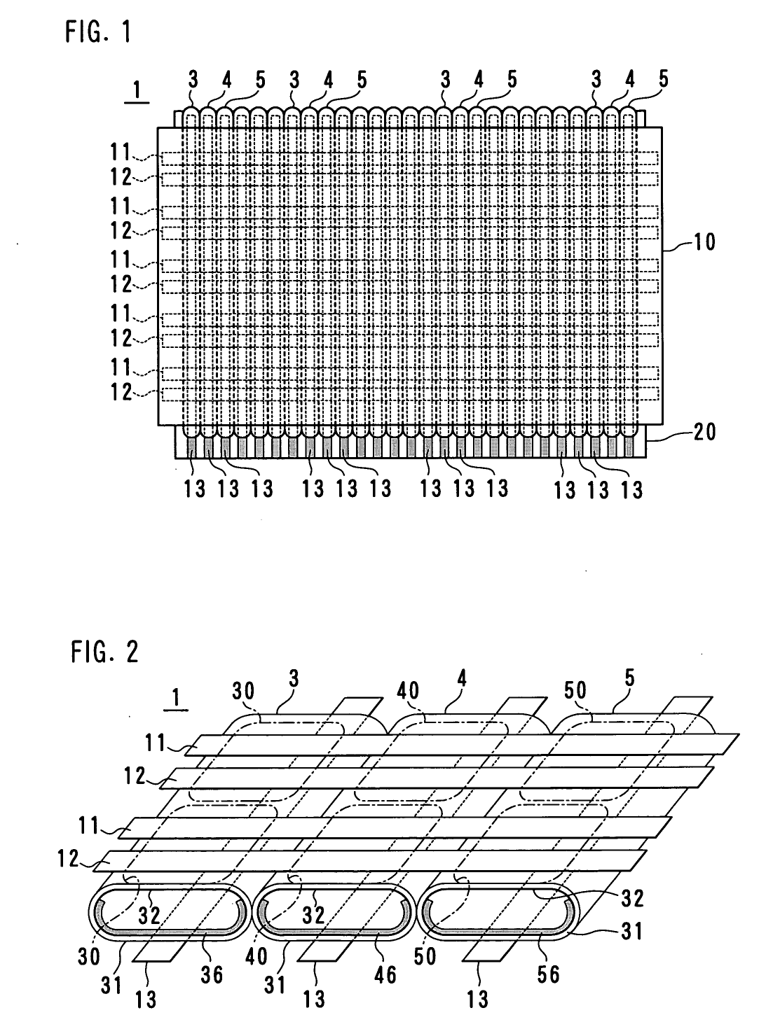

FIG. 1 is a diagram showing an outline of a general structure of a display device according to the present invention. The display device 1 includes gas discharge display tubes 3, 4 and 5 arranged in parallel, an electrode supporting plate 10 on the front side through which light can pass, and an electrode supporting plate 20 on the back side. The electrode supporting plate 10 is provided with first electrodes 11 and second electrodes 12 arranged to cover the length crossing all the many gas discharge display tubes 3, 4 and 5. The electrode supporting plate 20 is provided with third electrode 13 arranged to cover the entire length of each of the gas discharge display tubes 3, 4 and 5. Each of the gas discharge display tubes 3, 4 and 5 corresponds to one third electrode 13.

FIG. 2 shows a structure of a main part of the display device. Each of the gas discharge display tubes 3, 4 and 5 includes a glass tube 31 as an enclosure having flat front and back faces, and it is a thin tubular display device having a length of approximately 1 meter and a width of approximately 1 mm. The gas discharge display tubes 3, 4 and 5 have the same structure except for fluorescent materials 36, 46 and 56 that determine light emission colors. The glass tube 31 has a function of a dielectric, and the inner surface thereof is covered with magnesia that is a secondary-electron emitting material. The fluorescent materials 36, 46 and 56 are arranged on the inner surface of the glass tube 31 and are unevenly distributed on the back side so as not to cover the front flat part. The light emission color of the fluorescent material 36 arranged in the gas discharge display tube 3 is red color (R), the light emission color of the fluorescent material 46 arranged in the gas discharge display tube 4 is green color (G), and the light emission color of the fluorescent material 56 arranged in the gas discharge display tube 5 is blue color (B). The glass tube 31 is filled with discharge gas for exciting ultraviolet rays toward the fluorescent materials 36, 46 and 56. In each of the gas discharge display tubes 3, 4 and 5, a plurality of discharge cells (hereinafter referred to cells) 30, 40 and 50 are formed and arranged in the axis direction. Positions of these cells 30, 40 and 50 are defined by the first electrode 11 and the second electrode 12 on the electrode supporting plate 10.

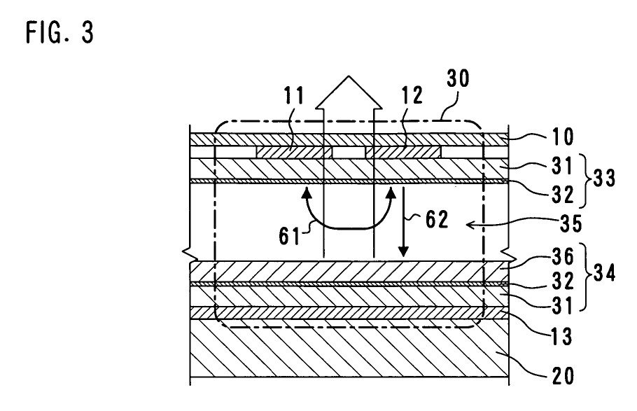

FIG. 3 shows a structure of a discharge cell. As described above, the basic structures of the cells 30, 40 and 50 are the same. Therefore, here is the cell 30 of the gas discharge display tube 3 shown as a representative.

The structure of the cell 30 is a three-electrode surface discharge structure that is similar to that of a typical plasma display panel. On the front side of a discharge gas space 35, the first electrode 11 and the second electrode 12 are arranged neighboring to each other. They constitute a pair of electrodes for a surface discharge 61 (a pair of surface discharge electrodes). Between the pair of surface discharge electrodes and the discharge gas space 35, there is a first insulator 33 made of the glass tube 31 and a magnesia film 32. The first insulator 33 has a thickness of approximately 100 μm. On the back side of the discharge gas space 35, the third electrodes 13 extend in the direction crossing the pair of surface discharge electrodes. The third electrodes 13 are arranged so as to face the pair of surface discharge electrodes via the discharge gas space 35. The second electrode 12 of the pair of surface discharge electrodes is a scanning electrode. The second electrode 12 and the third electrode 13 constitute a pair of electrodes for a counter discharge 62 (a pair of counter discharge electrodes). Between the third electrode 13 and the discharge gas space 35, there is a second insulator 34 made of the glass tube 31, the magnesia film 32 and the fluorescent material 36. Note that the magnesia film 32 may be formed only on the surface discharge electrodes side on the inner surface of the glass tube 31. In this case, the second insulator 34 is made of the glass tube 31 and the fluorescent material 36.

The cell 30 has a structural characteristic that a length of the discharge gas space 35 in the front-back direction is 300 μm or more and that a counter discharge start voltage (Vf2) is higher than a surface discharge start voltage (Vf1). Specifically, the surface discharge start voltage (Vf1) is approximately within the range of 300-310 volts while the counter discharge start voltage (Vf2) is approximately within the range of 350-400 volts. The counter discharge start voltage (Vf2) here is a start voltage of the counter discharge in which the third electrode 13 becomes a cathode, and it is higher than a start voltage (Vf3) of the counter discharge in which the third electrode 13 becomes an anode. The values Vf2 and Vf3 are different because a secondary-electron emission action of the front magnesia film 32 works effectively when the third electrode 13 is an anode. Note that the discharge start voltage becomes approximately an average of Vf2 and Vf3 if an alternating voltage pulse is applied to the third electrode 13 and the second electrode 12 for measuring the discharge start voltage.

As long as Vf2>Vf1, it does not matter whether Vf3>Vf1 or Vf3≦Vf1. If Vf3>Vf2 holds in the structure of the device, however, it is necessary that Vf3>Vf2>Vf1 also holds.

In the display device 1 having the structure described above, a full color display can be realized similarly to a plasma display panel by using a sub frame method. A frame is replaced with a plurality of sub frames with weights of luminance, and each of the sub frames is assigned with a resetting period, an addressing period and a sustaining period. Such a driving sequence is known widely, so it will be described briefly. In the resetting period, as preparation of the addressing step, an electrified state of the first insulator 33 in all the cells is initialized. In other words, a difference of the electrified state between cells that were energized and cells that were not energized in the sustaining period immediately before is eliminated. In the addressing period, wall charge in the first insulator 33 is controlled in accordance with sub frame data, so that a predetermined wall voltage is generated at the pair of surface discharge electrodes in the cell to be energized in the next sustaining period. Then, in the sustaining period, discharge is generated a predetermined number of times corresponding to a luminance weight in the cell to be energized.

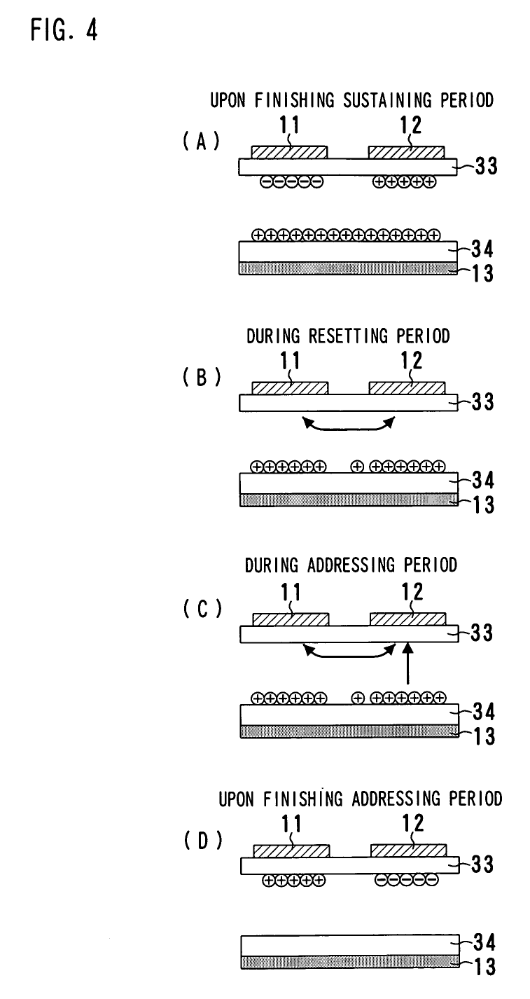

FIG. 4 shows a concept of driving processes according to the present invention. A characteristic of the driving sequence to which the present invention is applied is that positive charge is formed in the second insulator 34 in the sustaining step and that the reset process is performed so that the formed positive charge does not vanish.

A state (A) in FIG. 4 shows an electrified state of an energized cell when the sustaining period is finished. During the sustaining period, a polarity of the wall charge in the first insulator 33 switches every time when the surface discharge occurs between the first electrode 11 and the second electrode 12. If a potential of the third electrode 13 is set to a value lower than a potential of the anode of the surface discharge during the sustaining period, space charge is attracted by the third electrode 13 so that positive charge is accumulated in the second insulator 34 without the counter discharge.

A state (B) in FIG. 4 shows an electrified state of a cell in the resetting period. In the resetting period, the surface discharge is generated in a forcible manner in all the cells. In this case, the voltages among the three electrodes are controlled so that the counter discharge is not generated. Although some alteration is generated due to an influence of the surface discharge, a positive charge formed in the second insulator 34 during the sustaining period remains.

A state (C) in FIG. 4 shows an electrified state of a cell in the addressing period. A state (D) in FIG. 4 shows an electrified state of a cell to be energized when the addressing period is finished. In the case of writing form addressing, for example, the counter discharge between the third electrode 13 as an anode and the second electrode 12 as a cathode is generated during the addressing period in a cell to be energized during the sustaining period. The counter discharge becomes a trigger that causes the surface discharge. In this case, positive charge of the second insulator 34 contributes to a decrease of the driving voltage for generating the counter discharge.

When the driving method of the present invention is performed, any driving waveform can be used within a range that can realize the characteristic described above. As to the resetting period, however, it is preferable to use a combination of ramp waveforms that is known as being capable of a precise charge adjustment by micro discharge.

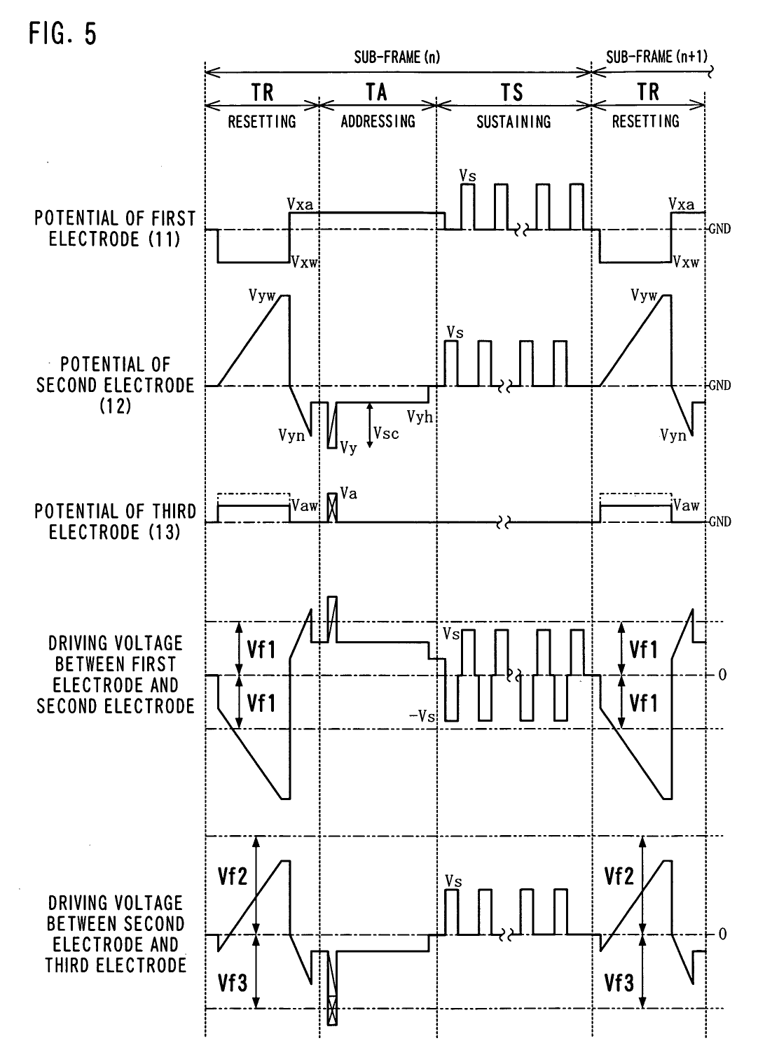

FIG. 5 shows an example of driving voltage waveforms. When the driving sequence described above is repeated, the resetting step can be regarded as a preprocess of the addressing step or a postprocess of the sustaining step. Here, the resetting step is regarded as a postprocess for convenience.

In the addressing period TA that is assigned to the n-th sub frame, all the first electrodes 11 are biased to the potential Vxa while all the second electrodes 12 are biased to the potential Vyh. Thus, all the cells are selected half. A scanning pulse having a peak value Vsc is applied to one second electrode 12 corresponding to the selected row, so that the second electrode 12 is temporarily biased to a selection potential Vy. In synchronization with this row selection, an addressing pulse is applied to the third electrode 13 corresponding to the selected column, so that the third electrode 13 is temporarily biased to an address potential Va. When the second electrode 12 and the third electrode 13 are biased, the counter discharge is generated in the selected cell for the addressing step. A concrete example of the potentials related to the addressing step is as follows.

Vxa: 30 volts

Vyh: −170 volts

Vy: −290 volts

Va: 100 volts

In the sustaining period TS that is assigned to the n-th sub frame, a sustaining pulse having a peak value Vs and the positive polarity is applied to the first electrode 11 and the second electrode 12 alternately. In the illustrated example, the sustaining pulse is applied first to the second electrode 12 and applied last to the first electrode 11. The peak value Vs is lower than the surface discharge start voltage Vf1 (|Vs|<|Vf1|). It is important that a potential of the third electrode 13 is kept to the ground potential during the whole sustaining period TS. When the sustaining pulse is applied, the anode is the positive potential while the cathode is the ground potential. Therefore, a potential of the third electrode 13 is lower than or equal to a potential of the first electrode 11 and a potential of the second electrode 12. This contributes to formation of the positive charge in the second insulator 34. Since the peak value Vs is substantially lower than the counter discharge start voltage Vf2, the counter discharge is not generated between the second electrode 12 and the third electrode 13 or between the first electrode 11 and the third electrode 13. The peak value Vs is 290 volts, for example.

In the resetting period TR that is assigned to the (n+1)th sub frame, a ramp waveform voltage is applied between the first electrode 11 and the second electrode 12 two times. In the first application of the voltage, the first electrode 11 is biased to the potential Vxw. A potential of the second electrode 12 is changed from the ground potential to the potential Vyw, and the third electrode 13 is biased to potential Vaw. The driving voltage between the first electrode 11 and the second electrode 12 is higher than the surface discharge start voltage Vf1. Therefore, micro discharge is generated in all the cells regardless of whether it is energized or not in the sustaining period immediately before. In the second application of the voltage, the first electrode 11 is biased to the potential Vxa while a potential of the second electrode 12 is changed from the ground potential to potential Vyn.

A concrete example of the potentials related to the resetting period is as follows.

Vxw: −80 volts

Vyw: 360 volts

Vaw: 0-100 volts

Vxa: 30 volts

For controlling electrode potentials in the resetting period TR, it is important to suppress generation of the counter discharge related to the third electrode 13. The condition of generating the surface discharge between the first electrode 11 and the second electrode 12 is |Vyw+vxw|>|Vf1|. Then, the condition that the counter discharge is not generated between the second electrode 12 and the third electrode 13 is |Vyw+Vaw|<|Vf2|.

Note that if the potential Vaw is set to the same value as the address potential Va as shown by the dot-dashed line in the drawing, the circuit structure of the driver for the third electrode 13 can be simplified.

According to the driving waveform described above, the anode for the last surface discharge during the sustaining period is the first electrode 11. Therefore, the resetting step is started in the electrified state in which the first electrode 11 side is negative and the second electrode 12 side is positive in the surface discharge gap. This is effective for decreasing the driving voltage in the resetting step.

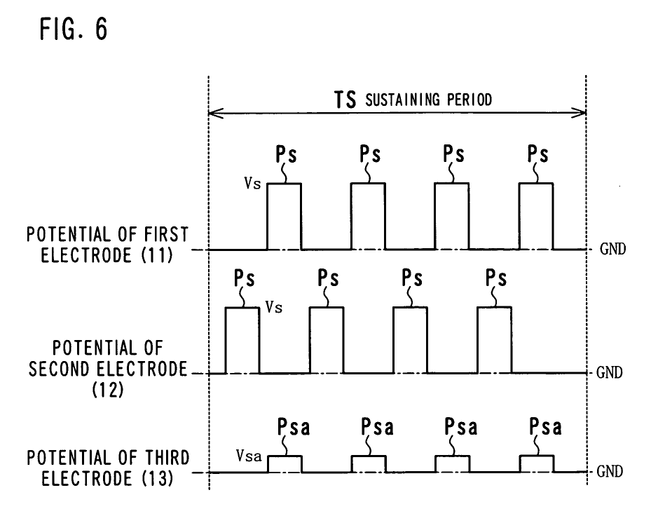

FIG. 6 is a diagram showing a variation of the driving voltage waveforms. In the sustaining period TS, a pulse Psa is applied to the third electrode 13 in synchronization with application of the sustaining pulse Ps to the first electrode 11. The polarity of the pulse Psa is the same as that of the sustaining pulse Ps. In other words, the pulse Psa decreases a voltage between the first electrode 11 and the third electrode 13 when the sustaining pulse Ps is applied. Thus, in the insulator 34 that covers the third electrode 13, more positive charge is accumulated in a part facing the second electrode 12 than in a part facing the first electrode 11. The counter discharge between the second electrode 12 and the third electrode 13 during the addressing period is localized so that probability of an address error due to discharge diffusion is decreased.

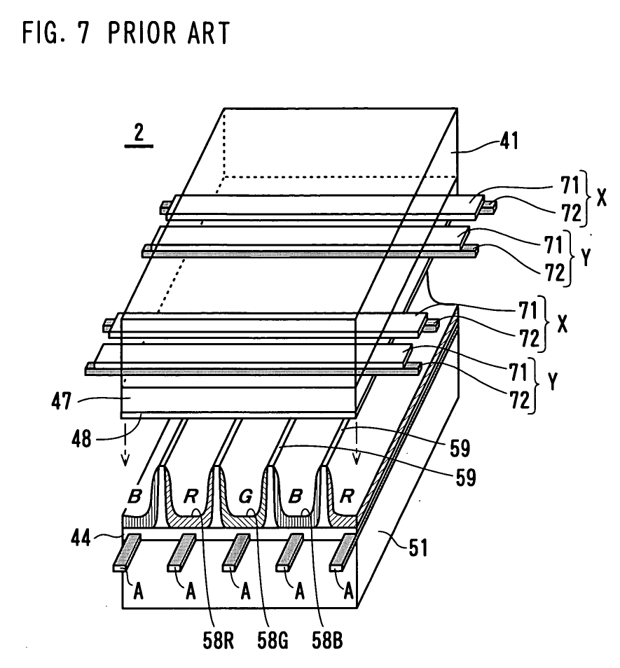

The driving method described above can be used not only for a display device made up of display tubes but also for a plasma display panel shown in FIG. 7.

In FIG. 7, the plasma display panel 2 is made up of a pair of plate-like bodies including a glass substrate on which cell elements are arranged. It includes a set of cells having a three-electrode surface discharge structure in which the counter discharge start voltage is higher than the surface discharge start voltage. On the inner surface of the front glass substrate 41, there are display electrodes X (first electrodes) and display electrodes Y (second electrodes) arranged in pairs so that a pair of the first and the second electrodes corresponds to one row of a matrix display. Each of the display electrodes X and Y is made up of a transparent conductive film 71 that forms a surface discharge gap and a metal film 72 that overlaps an edge portion of the transparent conductive film 71. The display electrodes X and Y are covered with a dielectric layer 47 made of silicon dioxide and with a protection film 48 made of magnesia. On the inner surface of the back glass substrate 51, there are address electrodes A so that one address electrode A corresponds to one column. The address electrodes A are covered with a dielectric layer 44, and partitions 59 are arranged on the dielectric layer 44 for dividing the discharge space into columns. The surface of the dielectric layer 44 and the side faces of the partitions 59 are covered with fluorescent material layers 58R, 58G and 58B for color display. Italic letters (R, G and B) in the drawing indicate light emission colors of the fluorescent materials. The color arrangement is a repeating pattern of R, G and B in which cells of each of the columns have the same color. The fluorescent material layers 58R, 58G and 58B are excited locally by ultraviolet rays emitted by the discharge gas so as to emit light.

### INDUSTRIAL APPLICABILITY

The present invention can be used for an image display that utilizes three-electrode surface discharge type discharge cells having a wide discharge gas space that is advantageous for improving luminance. It is suitable for driving a display device including discharge tubes in which an opposed electrode gap is enlarged easily and for driving a plasma display panel designed to have a sufficiently large opposed electrode gap.

1. A method for driving a gas discharge display panel having a plurality of discharge cells each of which includes a first electrode, a second electrode neighboring the first electrode, a third electrode that is opposed to the second electrode via a discharge gas space, a first insulator disposed between the first electrode as well as the second electrode and the discharge gas space, and a second insulator disposed between the third electrode and the discharge gas space, each of the discharge cells having a structural characteristic that a discharge start voltage between the third electrode and the second electrode is higher than a discharge start voltage between the first electrode and the second electrode, the method comprising:
an addressing step for forming a state in which a necessary quantity of wall charge is accumulated in the first insulator in discharge cells to be energized;
a sustaining step for generating a discharge between the first electrode and the second electrode in the discharge cells to be energized; and
a resetting step for initializing the wall charge in the first insulator in all the discharge cells, wherein
in the addressing step, a discharge is generated by using the third electrode as an anode between the second electrode and the third electrode in the discharge cells to be energized or in discharge cells to be not energized,
in the sustaining step, the wall charge of a positive polarity is accumulated in the second insulator in all the discharge cells, and
in the resetting step, a discharge is generated not between the second electrode and the third electrode but between the first electrode and the second electrode.

2. The driving method of the gas discharge display panel according to claim 1, wherein in the sustaining step a potential of the third electrode in all the discharge cells is set to a potential that is always the same as or lower than a potential of each of the first and the second electrodes.

3. The driving method of the gas discharge display panel according to claim 2, wherein in the sustaining step a pulse for decreasing a potential difference between the first electrode and the third electrode is applied to the third electrode in synchronization with application of the pulse to the first electrode.

4. The driving method of the gas discharge display panel according to claim 1, wherein in the sustaining step an anode for a last discharge is the first electrode regardless of the number of times of the discharge.

5. The driving method of the gas discharge display panel according to claim 1, wherein in the resetting step the third electrode in all the discharge cells is biased so as to decrease a potential difference between the third electrode and the second electrode.

6. The driving method of the gas discharge display panel according to claim 5, wherein in the addressing step an addressing pulse having the positive polarity is applied to the third electrode in the discharge cells to be energized or to the discharge cells to be not energized, and in the resetting step a bias voltage of the third electrode in all the discharge cells is the same as a peak value of the addressing pulse.

7. A method for driving a gas discharge display tube having a plurality of discharge cells that are capable of selective light emission, in which each of the discharge cells includes a first electrode, a second electrode neighboring the first electrode, a third electrode facing the second electrode via a discharge gas space, a first insulator disposed between the first electrode as well as the second electrode and the discharge gas space, and a second insulator disposed between the third electrode and the discharge gas space, and each of the discharge cells has a structural characteristic that a discharge start voltage between the third electrode and the second electrode is higher than a discharge start voltage between the first electrode and the second electrode, the method comprising:
an addressing step for forming a state in which a necessary quantity of wall charge is accumulated in the first insulator in discharge cells to be energized;
a sustaining step for generating a discharge between the first electrode and the second electrode in the discharge cells to be energized; and
a resetting step for initializing the wall charge in the first insulator in all the discharge cells, wherein
in the addressing step, a discharge is generated by using the third electrode as an anode between the second electrode and the third electrode in the discharge cells to be energized or in discharge cells to be not energized,
in the sustaining step, the wall charge of a positive polarity is accumulated in the second insulator in all the discharge cells, and
in the resetting step, a discharge is generated not between the second electrode and the third electrode but between the first electrode and the second electrode.

8. A method for driving a display device including a plurality of gas discharge display tubes each of which has a plurality of discharge cells that are capable of selective light emission, in which each of the discharge cells includes a first electrode, a second electrode neighboring the first electrode, a third electrode facing the second electrode via a discharge gas space, a first insulator disposed between the first electrode as well as the second electrode and the discharge gas space, and a second insulator disposed between the third electrode and the discharge gas space, and each of the discharge cells has a structural characteristic that a discharge start voltage between the third electrode and the second electrode is higher than a discharge start voltage between the first electrode and the second electrode, the method comprising:
an addressing step for forming a state in which a necessary quantity of wall charge is accumulated in the first insulator in discharge cells to be energized;
a sustaining step for generating a discharge between the first electrode and the second electrode in the discharge cells to be energized; and
a resetting step for initializing the wall charge in the first insulator in all the discharge cells, wherein
in the addressing step, a discharge is generated by using the third electrode as an anode between the second electrode and the third electrode in the discharge cells to be energized or in discharge cells to be not energized,
in the sustaining step, the wall charge of a positive polarity is accumulated in the second insulator in all the discharge cells, and
in the resetting step, a discharge is generated not between the second electrode and the third electrode but between the first electrode and the second electrode.

9. A method for driving a plasma display panel in which each of discharge cells constituting a screen includes a first electrode, a second electrode neighboring the first electrode, a third electrode facing the second electrode via a discharge gas space, a first insulator disposed between the first electrode as well as the second electrode and the discharge gas space, and a second insulator disposed between the third electrode and the discharge gas space, and each of the discharge cells has a structural characteristic that a discharge start voltage between the third electrode and the second electrode is higher than a discharge start voltage between the first electrode and the second electrode, the method comprising:
an addressing step for forming a state in which a necessary quantity of wall charge is accumulated in the first insulator in discharge cells to be energized;
a sustaining step for generating a discharge between the first electrode and the second electrode in the discharge cells to be energized; and
a resetting step for initializing the wall charge in the first insulator in all the discharge cells, wherein
in the addressing step, a discharge is generated by using the third electrode as an anode between the second electrode and the third electrode in the discharge cells to be energized or in discharge cells to be not energized,
in the sustaining step, the wall charge of a positive polarity is accumulated in the second insulator in all the discharge cells, and in the resetting step, a discharge is generated not between the second electrode and the third electrode but between the first electrode and the second electrode.
